(19) United States
(12) Patent Application Publication
(10) Pub. No.: US 2005/0190926 A1
(43) Pub. Date: Sep. 1, 2005

(54) Wave reduction sampling method of signal output

(76) Inventor: Jyh-Hwang Wang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/788,362

(22) Filed: Mar. 1, 2004

(51) Int. Cl. H04R 5/00

(52) U.S. Cl. 381/28

(57) ABSTRACT

The present invention discloses a wave reduction sampling method of signal output. The method includes smoothing the original digital signal at a host terminal to rebuild a simulating signal, and sampling the simulating signal with a sampling rate to obtain a reductive signal. The sampling rate is an operating frequency of an audio/image outputting apparatus divided by a transmission multiple value. The claimed invention transfers the sampling rate by software at the host terminal to reduce the signal to output, and has advantages of having flexible outputting frequency, being suitable to any operating frequency, omitting the clock synthesizer and reducing the cost.

### BACKGROUND OF INVENTION

1. Field of the Invention

The invention relates to an signal outputting technology, and more particularly, to a wave reduction sampling method of signal output that allow the outputting frequency being suitable to any operating frequency without limitation.

2. Description of the Prior Art

Output of acoustics or images involves sampling techniques. Taking output of acoustics for example, the standard sampling operating frequency of the playing apparatus is generally 32 KHz, 48 KHz and 96 KHz, or 22.05 KHz and 44.1 KHz, wherein the sampling rate or sampling frequency of acoustics means the recording (sampling) times of the audio wave in one second.

The conventional sampling method of acoustics output is shown in FIG. 1. The host 10 connects a USB speaker 12 through the USB transmission interface. The communication frequency of the host 10 and the USB speaker 12 is 12 MHz and the playing frequency of the speaker 12 is 12.288 MHz, so the speaker 12 should boost the audio frequency to 12.288 MHz. The conventional method is installing an acoustics receiving device 13, a clock synthesizer 14, a digital to analog converter (DAC) 16 and an amplifier 18 in the USB speaker 12. When the host 10 samples an audio data with the frequency of 48 KHz and outputs to the USB speaker 12, the acoustics receiving device 13 receives firstly and the clock synthesizer 14 adjusts the operating frequency from 12 MHz to 12.288 MHz, and the DAC 16 and the amplifier 18 convert the digital signal to analog and output it. But the sampling method of acoustics output is limited by the operating frequency of the speaker 12. The frequency synchronization between the host 10 and the USB speaker 12 should be considered, and the clock synthesizer 14 should be added in the USB speaker 12 to adjust the frequency. In addition, different operating frequencies should use different clock synthesizers 14, and this is very inconvenient.

Another prior technology is building the sampling rate converter in the speaker, and transferring the sampling rate by the speaker. However, the structure of the speaker will become larger and increase the manufacture cost.

Hence, the present invention discloses a wave reduction sampling method of signal output that transferring the sampling rate at the host terminal with software or firmware to overcome the disadvantages of the prior art.

### SUMMARY OF INVENTION

It is therefore a primary objective of the claimed invention to provide a wave reduction sampling method of signal output that uses software to transfer the sampling rate and reduce the signal to provide an equivalent signal output, and the outputting frequency at the host terminal is not limited by the standard operating frequency, so that the problem of frequency synchronization is completely solved.

It is therefore another objective of the claimed invention to provide a wave reduction sampling method of signal output that has the advantage of being suitable to any operating frequency.

It is therefore a further objective of the claimed invention to provide a wave reduction sampling method of signal output that omits the clock synthesizer and the sampling rate converter to reduce the cost.

According to the claimed invention, the wave reduction sampling method of signal output reduces an original digital signal directly at a host terminal to provide an audio/image outputting apparatus to output. The method includes steps of: firstly, smoothing the original digital signal at the host terminal to rebuild a simulating signal; and then, sampling the simulating signal with a sampling rate, wherein the sampling rate is an operating frequency of the audio outputting apparatus divided by a transmission multiple value, obtaining a reductive signal by sampling, and transmitting the reductive signal to the audio outputting apparatus.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of the hardware apparatus of the acoustics sampling output according to the prior art.

FIG. 2 is a schematic diagram of the hardware apparatus of the acoustics sampling output according to the present invention.

FIG. 3 is a schematic diagram of the sampling method of the acoustics output according to the present invention.

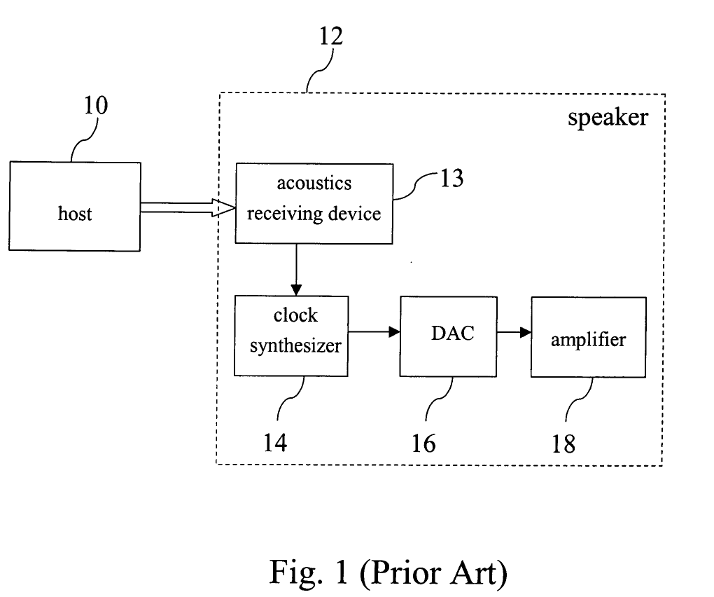

FIG. 4 is a schematic diagram of the connection between the speaker and the DAC according to the present invention.
10 host
12 speaker
13 acoustics receiving device
14 clock synthesizer
20 host terminal
22 speaker
23 acoustics receiving device
24 digital to analog converter

### DETAILED DESCRIPTION

While outputting a signal, the original digital signal is smoothed and a simulating signal is rebuilt at the host terminal, and then the simulating signal is sampled with a sampling rate to produce a reductive signal and output it. That will make the final outputting frequency of the host terminal unfixed.

Output of acoustics or images involves sampling techniques. Generally, the standard sampling rate of an audio playing apparatus is 44.1 KHz, 32 KHz, 48 KHz and 96 KHz, and the sampling rate of acoustics means the sampling times of the audio wave in one second. The wave reduction sampling method of the present invention is suitable for both audio signals and image signals, and in the following description of the present invention, acoustics outputting will be the embodiment to describe the details of the present method.

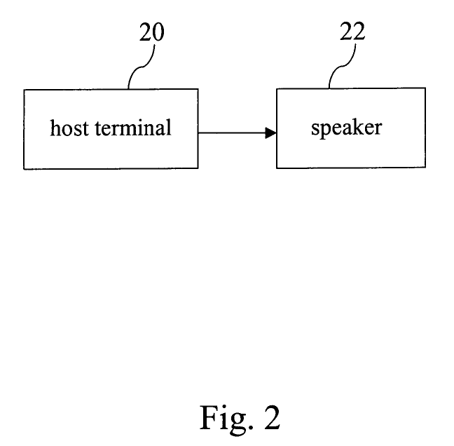

FIG. 2 shows the hardware apparatus of the claimed wave reduction sampling method. A host terminal 20 connects an audio outputting apparatus through a transmission interface. The audio outputting apparatus is usually a speaker 22 and the transmission interface is USB, IEEE 1394 or bluetooth. While the transmission interface is USB 1.1, the operating frequency of the speaker 22 is 12 MHz, while the transmission interface is USB 2.0, the operating frequency of the speaker 22 is 30 MHz, and while the transmission interface is IEEE 1394, the operating frequency of the speaker 22 is 400 MHz. The embodiment described below is illustrated by using USB 1.1 as transmission interface to explain the procedure of sampling, reducing and outputting the audio wave at the host terminal 20 according to the present invention.

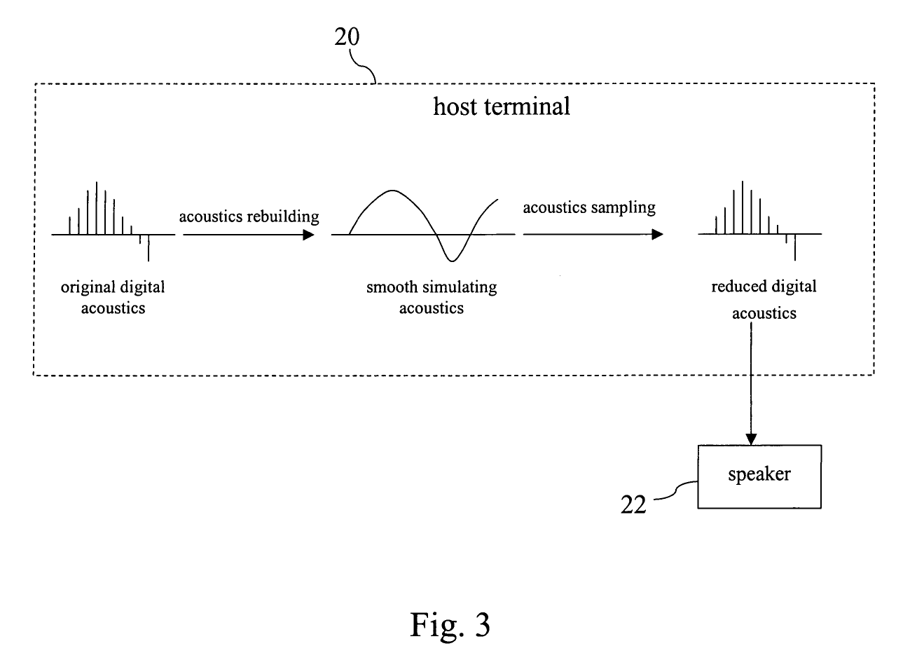

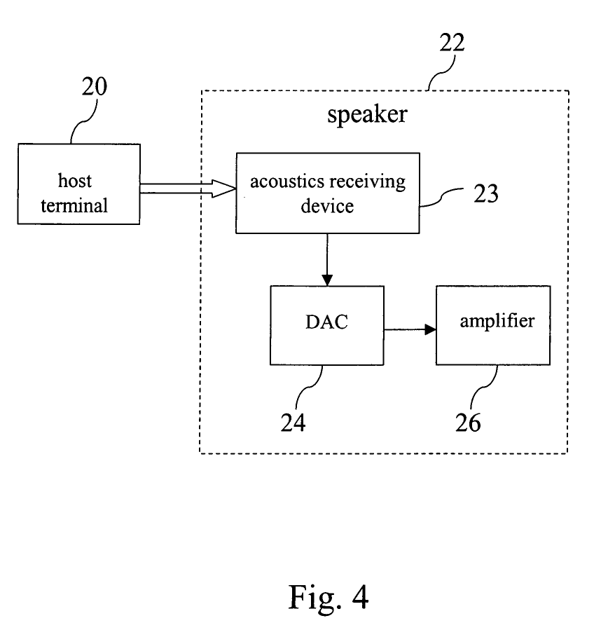

FIG. 3 is a schematic diagram of the sampling method of the acoustics output according to the present invention. The audio wave reduction sampling method that is achieved by utilizing software or firmware at the host terminal 20 includes steps of: firstly, the host terminal 20 smoothes the original digital acoustics DSWᵢₙ with a matching frequency fₛ₁ to rebuild the original digital acoustics DSWᵢₙ to a smooth simulating acoustics; the frequency fₛ₁ is generally 44.1 KHz, 32 KHz, 48 KHz or 96 KHz, and the frequency fₛ₁ must match the inputting frequency of the original digital acoustics DSWᵢₙ, for example, while DSWᵢₙ is 16 KHz, fₛ₁ is 16 KHz to be used for rebuilding; and if DSWᵢₙ is 48 KHz, fₛ₁ is 48 KHz to be used for rebuilding. After rebuilding the simulating acoustics with the frequency fₛ₁, the simulating acoustics is sampled with a sampling rate fₛ₂ and obtains a reductive acoustics DSWₒᵤₜ to output to the speaker 22.

The value of the sampling rate fₛ₂ is the operating frequency of the speaker 22 divided by a transmission multiple. If the operating frequency is 12 MHz and the transmission multiple is 256, the sampling rate fₛ₂ can be 46.875 KHz by dividing 12 MHz with 256. Since the speaker 22 is a USB 1.1 transmission interface, after electrically connecting the speaker 22 and the host terminal 20, the software will actively inform the host terminal 20 to using the sampling rate 46.875 KHz. Besides, the transmission multiple is generally 2ⁿ, such as 128, 256, and 512, and 256 is the most popular one but not limited.

In addition, the sampling rate fₛ₂ of the present invention is obtained before rebuilding the original digital acoustics. After detecting the operating frequency of the speaker 22, the sampling rate can be calculated in accordance with the operating frequency. Or after rebuilding the simulating acoustics and before sampling the simulating acoustics, detecting the operating frequency of the speaker 22 and calculating the sampling rate in accordance with the operating frequency.

After using the present method to reduce an original digital acoustics DSWᵢₙ to a reduced digital acoustics DSWₒᵤₜ at the host terminal 20, the reduced digital acoustics DSWₒᵤₜ is immediately sent to the speaker 22. Please refer to FIG. 4, the speaker 22 generally comprises an acoustics receiving apparatus 23, a digital to analog converter (DAC) 24 and an amplifier 26. When the host terminal 20 samples an audio wave with a suitable frequency and outputs it to the speaker 22, the acoustics receiving apparatus 23 will receive the audio data, the DAC 24 will transfer the audio data from digital to analog that can be heard, and the amplifier 26 will amplify the analog signal for playing.

Hence, while outputting the signal, the present invention can rebuild a simulating signal at the host terminal and directly sampling the simulating signal with a sampling rate to produce a reduced signal for providing the audio/image outputting apparatus to output. With providing the equivalent audio/image output, the signal can be reduced and outputted by transferring the sampling rate with software, and the final outputting frequency of the host terminal is no longer limited by the standard operating frequency. In contrast to the prior art, the present invention is suitable to any operating frequency without the limitation of frequency synchronization between the speaker and the host, so that the clock synthesizer and the sampling rate converter can be omitted and the cost can be reduced.

Those skilled in the art will readily observe that numerous modifications and alterations of the device may be made while retaining the teachings of the invention. Accordingly, the above disclosure should be construed as limited only by the metes and bounds of the appended claims.

1. A wave reduction sampling method of signal output for reducing an original digital signal at a host terminal to provide an outputting apparatus to output, the wave reduction sampling method of signal output comprising steps of:
smoothing the original digital signal with a standard operating frequency at the host terminal to rebuild a simulating signal; and
sampling the simulating signal with a sampling rate, wherein the sampling rate is an operating frequency of the outputting apparatus divided by a transmission multiple value, obtaining a reductive signal by sampling, and transmitting the reductive signal to the outputting apparatus.

2. The wave reduction sampling method of signal output of claim 1, before the step of rebuilding the original digital signal, further comprising a step of detecting the operating frequency of the outputting apparatus and calculating the sampling rate in accordance with the operating frequency.

3. The wave reduction sampling method of signal output of claim 1, before the step of sampling the simulating signal, further comprising a step of detecting the operating frequency of the outputting apparatus and calculating the sampling rate in accordance with the operating frequency.

4. The wave reduction sampling method of signal output of claim 1, wherein the outputting apparatus is selected from an audio outputting apparatus and an image outputting apparatus.

5. The wave reduction sampling method of signal output of claim 4, wherein the audio outputting apparatus is a speaker.

6. The wave reduction sampling method of signal output of claim 1, wherein the standard operating frequency is selected from 44.1 KHz, 32 KHz, 48 KHz and 96 KHz.

7. The wave reduction sampling method of signal output of claim 1, wherein the outputting apparatus is connected to the host terminal through a transmission interface, and the transmission interface is selected from USB, IEEE 1394 and bluetooth.

8. The wave reduction sampling method of signal output of claim 1, wherein the operating frequency of the outputting apparatus is selected from 12 MHz, 30 MHz and 400 MHz.

9. The wave reduction sampling method of signal output of claim 1, wherein the transmission multiple value is 2ⁿ.

10. The wave reduction sampling method of signal output of claim 1, wherein the outputting apparatus further comprises a digital to analog converter to convert the reductive signal to an analog signal for outputting.
